(19) United States
(12) Patent Application Publication
(10) Pub. No.: US 2023/0259972 A1
(43) Pub. Date: Aug. 17, 2023

(54) CONSUMER COMMUNICATIONS ALLOCATION SYSTEMS AND METHODS

(71) Applicant: SCHNUCK MARKETS, INC., Saint Louis (MO)

(72) Inventors: Yao XIE, Saint Louis, MO (US); Anupriya AGRAWAL, Saint Louis, MO (US); Ann EHNERT, Saint Louis, MO (US); Chace MACMULLAN, Saint Louis, MO (US); Colin LLOYD, Saint Peters, MO (US); Thomas E. HENRY, JR., Wildwood, MO (US); Yifan ZHAO, Chesterfield, MO (US)

(21) Appl. No.: 18/108,060

(22) Filed: Feb. 10, 2023

Related U.S. Application Data
(60) Provisional application No. 63/309,279, filed on Feb. 11, 2022.

(51) Int. Cl. G06Q 30/0251

(52) U.S. Cl. CPC G06Q 30/0254; G06Q 30/0269

(57) ABSTRACT

Devices, systems, and methods for allocating consumer communications can include obtaining consumer activity data, designating a number of consumer communication campaigns concerning consumer features based on the consumer activity data, entering consumer activity data as inputs to one machine learning model for each determined consumer communication campaign, each machine learning model configured determine a campaign consumer activation profile based on the entered consumer activity data, and assigning the consumer communication campaigns to consumers based on the determined campaign consumer activation profiles.

### CROSS-REFERENCE

This utility application claims the benefit of priority to U.S. Provisional Patent Application No. 63/309,279, entitled “CONSUMER ALLOCATION SYSTEM AND METHODS”, filed on Feb. 11, 2022, the contents of which are hereby incorporated by reference in their entirety.

### TECHNICAL FIELD

The present disclosure relates to devices, systems, and methods in the field of consumer communication. More particularly, the present disclosure relates to devices, systems, and methods in the field of consumer communication via allocation.

### BACKGROUND

Meaningful consumer communications can assist in improving the consumer experience, but can also require labor-intensive efforts to ensure the meaningfulness of those communications. Indeed, poorly managed consumer communications can have a deleterious effect on the impression and/or experience of the consumer, whether by immediate or insidious effect. Moreover, timely and/or meaningful consumer communications can reinforce positive connections with consumers. Within the present disclosure, consumer communication allocation can be implemented to increase meaningfulness in consumer communications and/or to reduce improper communications for particular consumers.

### SUMMARY

According to an aspect of the present disclosure, a method of allocating communications for consumers may comprise obtaining consumer activity data at the consumer level and program level, designating a number of consumer communication campaigns concerning consumer features based on the consumer activity data at the consumer and program levels, entering consumer activity data at the consumer and program levels as inputs to one machine learning model for each determined consumer communication campaign, each machine learning model configured to determine a campaign consumer activation profile based on the entered consumer activity data. In some embodiments, the method may include assigning consumer communication campaigns for communication based on the determined campaign consumer activation profiles. The method may include communicating designated consumer communications with each consumer according to the assigned consumer communication campaign.

In some embodiments, assigning consumer communication campaigns may include aligning each campaign consumer activation profile across the consumer communication campaigns. Aligning may include entering the campaign consumer activation profiles as inputs to a valuation machine learning model to generate assembled consumer activation profiles. The assembled consumer activation profiles may include rescaling of each campaign consumer activation profile for equality between false positive ratios of each campaign consumer activation profile.

In some embodiments, the method may further comprise valuating each consumer according to each assembled consumer campaign profile to determine a best-next consumer campaign allocation for each consumer. Valuating each consumer may be conducted by the valuation machine learning model to generate the best-next consumer campaign allocation for each consumer based on a determination of the consumer interval value attributed for each consumer communication campaign, and assigning the consumer communication campaigns for communication may include assigning based on the best-next consumer campaign allocation for each consumer. In some embodiments, assigning based on the best-next consumer campaign allocation may include assigning to the consumer communication campaign identified as the best-next consumer campaign allocation for each consumer.

In some embodiments, each designated consumer communication for the consumer communication campaigns may be distinct. Each designated consumer communication of the consumer communication campaigns may include different consumer product information.

In some embodiments, the method may further include repeating at least the assigning, and the communicating. The method may further include repeating obtaining consumer activity data at at least one of the consumer and program levels. The method may further include repeating the designating. Repeating the designating may include adding at least one new consumer communication campaign.

In some embodiments, adding at least one new consumer communication campaign may include establishing a machine learning model for the at least one new consumer communication campaign. Determining a campaign consumer activation profile may include determining a likelihood of consumer activation for a given consumer communication campaign. The likelihood of consumer activation for a given consumer communication campaign may include a likelihood of consumer acceptance of a given communication according to the given consumer communication campaign. Assigning may include determining the likelihood of consumer activation for a given consumer communication campaign by the machine learning model for the given consumer communication campaign.

According to another aspect of the present disclosure, a system for allocating communications for consumers may comprise at least one processor for executing instructions stored on memory for conducting operations including: obtaining consumer activity data at the consumer level and the program level, designating a number of consumer communication campaigns concerning consumer features based on the consumer activity data at the consumer and program levels, entering consumer activity data at the consumer and program levels as inputs to one machine learning model for each determined consumer communication campaign, each machine learning model configured to determine a campaign consumer activation profile based on the entered consumer activity data. The operations may further include assigning the number of consumer communication campaigns for communication based on the determined campaign consumer activation profiles. In some embodiments, the system may include communications circuitry for communicating designated consumer communications with each consumer according to the assigned consumer communication campaign from the at least one processor.

In some embodiments, assigning operations may include aligning each campaign consumer activation profile across the consumer communication campaigns. The at least one processor may include a valuation machine learning model. Aligning may include entering the campaign consumer activation profiles as inputs to the valuation machine learning model to generate assembled consumer activation profiles. The assembled consumer activation profiles include rescaling of each campaign consumer activation profile for equality between false positive ratios of each campaign consumer activation profile.

In some embodiments, the method may further comprise valuating each consumer according to each valuation consumer campaign profile to determine a best-next consumer campaign allocation for each consumer. Valuating each consumer may be conducted by the valuation machine learning model to generate the best-next consumer campaign allocation for each consumer based on a determination of the consumer interval value attributed for each consumer communication campaign. Assigning the consumer communication campaigns for communication may include assigning consumers based on the best-next consumer campaign allocation for each consumer. Assigning based on the best-next consumer campaign allocation may include assigning the consumer communication campaign identified as the best-next consumer campaign allocation for each consumer.

In some embodiments, the method may include repeating the designating. Repeating the designating may include adding at least one new consumer communication campaign. Adding at least one new consumer communication campaign may include establishing a machine learning model for the at least one new consumer communication campaign.

These and other features of the present disclosure will become more apparent from the following description of the illustrative embodiments.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1 is a diagrammatic view of certain considerations of a consumer allocation system according to aspects of the present disclosure;

FIG. 2 is a flow diagram indicating operational aspects applied by the consumer allocation system according to aspects of the present disclosure;

FIG. 3 is a flow diagram indicating operational aspects applied by the consumer allocation system according to aspects of the present disclosure;

FIG. 4 is a graph indicating alignment operational aspects applied by the consumer allocation system according to aspects of the present disclosure;

FIG. 5 is a graphical illustration of certain activity data which can be employed by the consumer allocation system according to aspects of the present disclosure;

FIG. 6 is a flow diagram indicating operational aspects concerning machine learning models of the consumer allocation system according to aspects of the present disclosure;

FIG. 7 is a graphical illustration of a validation aspect of the consumer allocation system according to aspects of the present disclosure; and

FIG. 8 is a diagrammatic view of features of the consumer allocation system according to aspects of the present disclosure.

### DETAILED DESCRIPTION OF THE DRAWINGS

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Group communications present nuanced challenges including rapid change in the suitability of previous communications. While updating communication information can generally provide timely delivery of relevant information to group members, a multitude of rapidly changing factors can influence the effect of the communication on the particular member receiving the communication. Yet, in the context of consumers, tailored communications can be labor intensive and/or can be inefficient in managing many hundreds, or even thousands, of consumers (customers) with diverse and/or changing subjective factors, e.g., changing needs or influences.

Allocating communications for consumers according to communication campaigns can reduce the degrees of variability in addressing the rapidly changing factors for consideration in providing preferred consumer communications. Such communication campaigns can enhance communications with consumers for one or both of the recipient and the provider. For example, by properly allocating communications for consumers according to consumer communication campaigns, the individual consumers can receive communications more appropriate to their needs, reducing less-relevant communication subject matter and/or reducing effort in discerning which communications are appropriate. Additionally, proper allocation can reduce the burden on the provider to conform communications to individual needs and/or desires, focus efforts on relevant subject matter, on an ongoing and/or timely basis.

In the context of continually changing grocery environment, rapidly changing aspects of inventory and/or consumers can require near constant adaptation of communications to consumers in order to properly and/or efficiently inform consumers regarding product aspects, such as availability, offerings, and/or branding. Yet, tailoring each communication for particular consumers can be challenging or can miss-the-mark for other consumers.

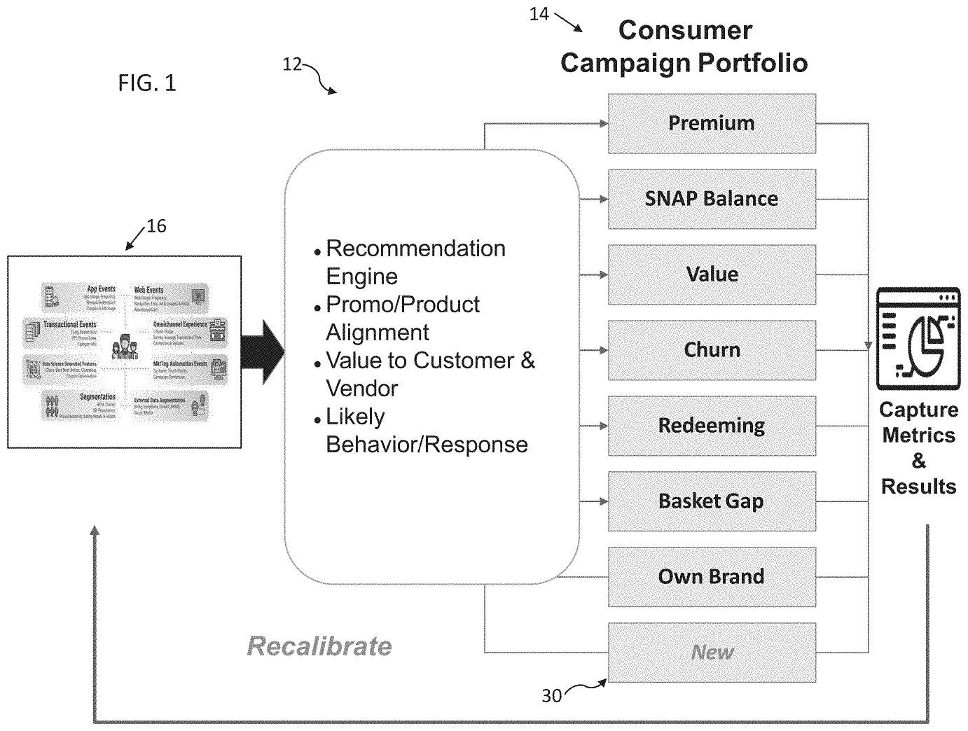

As suggested in FIG. 1, a consumer communication allocation system (12) can implement a consumer campaign portfolio 14 for allocating consumers to receive consumer communications. The consumer campaign portfolio 14 includes a variety of consumer communication campaigns, illustratively including Premium, Supplemental Nutrition Assistance Program (SNAP) Balance, Value, Churn, Redeeming, Basket Gap, and Own Brand consumer communication campaigns. For example, the SNAP Balance campaign may include communications for consumers in consideration of balance (and/or timing) of assistive benefits programs such as SNAP programs in developing appropriate communications allocated for consumers. Other campaigns may include related aspects, such as Premium campaign may include communications for consumers with high value of price per item and/or high percentage of promotional items, Value campaign may include communications for consumers with low value of price per item in basket and/or low percentage of promotional items in basket, Churn campaign may include communications for consumers who have not shopped within 14 days and/or have higher likelihood to stop participating, Redeeming campaign may include communications for consumers not currently redeeming coupons (e.g., not engaged digitally), Basket gap may include communications for customers patronizing certain departments but not others (e.g., patronizing dairy, but not produce), Own Brand may include communications for customers with low store-brand participation. The consumer allocation system 12 can allocate communications for consumers for each consumer communication campaign as discussed in additional detail herein.

The consumer allocation system 12 can receive consumer activity data 16 for designating relevant consumer communication campaigns for the portfolio 14. The consumer allocation system 12 can determine consumer communication allocation for the various consumer communication campaigns based on campaign consumer activation profiles. For example, each consumer communication campaign can be assigned for communication with a particular group of consumers. The consumer allocation system 12 can designate the relevant consumer communication campaigns by selecting existing campaigns or establishing new campaigns, as discussed in additional detail herein.

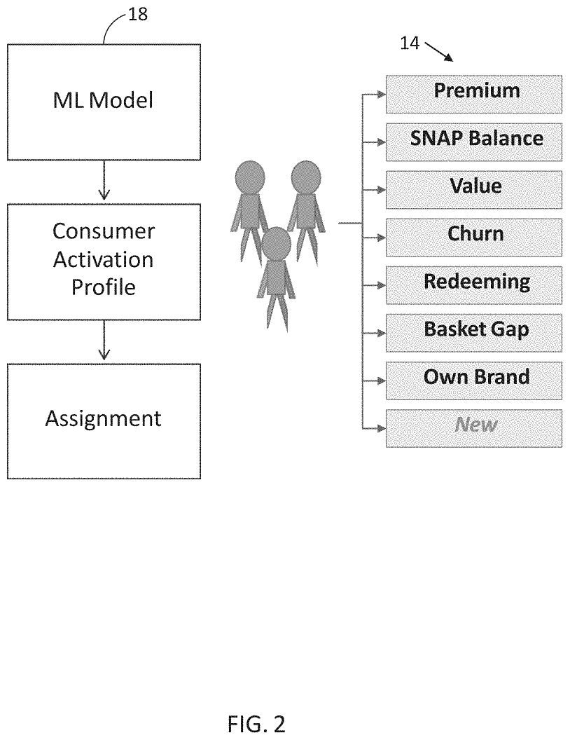

Referring to FIG. 2, the consumer allocation system 12 illustratively includes a machine learning model 18 for each consumer communication campaign. Each machine learning model 18 is configured to determine a campaign consumer activation profile for the corresponding campaign for each consumer based on the consumer activity data. The campaign consumer activation profiles illustratively includes the likelihood of consumer activation for a given consumer communication campaign. The likelihood of consumer activation can include a likelihood of consumer acceptance of a given communication, for example, consumer acceptance can include acceptance of an offer, use of a coupon for a transaction, redemption of rebate, sampling, registration for information, and/or related action responsive to a given consumer communication. Each consumer communication campaign can be assigned for communications based on the campaign consumer activation profile.

Consumer communication campaigns assigned for communication with a particular consumer can provide communications arranged by that campaign for the particular consumer. Such campaign-specific communications can be more tailored to the particular community of assigned consumers, increasing the relevancy of communications and/or decreasing the likelihood of irrelevant communications.

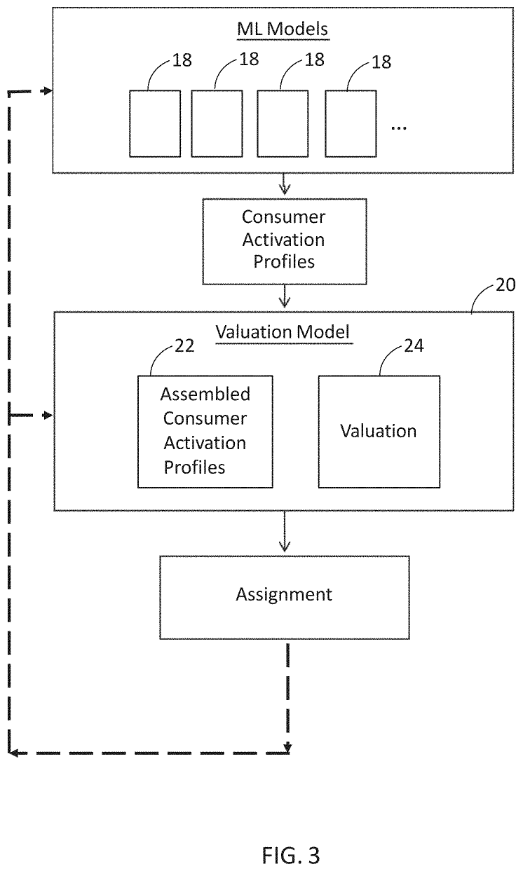

Referring now to FIG. 3, a multi-level arrangement of the consumer allocation system 12 is suggested. The machine learning models 18 of the individual consumer communication campaigns each generate a campaign consumer activation profile for each consumer based on the consumer activity data. The individual campaign consumer activation profiles are entered as input information to an additional machine learning model embodied as a valuation machine learning model 20.

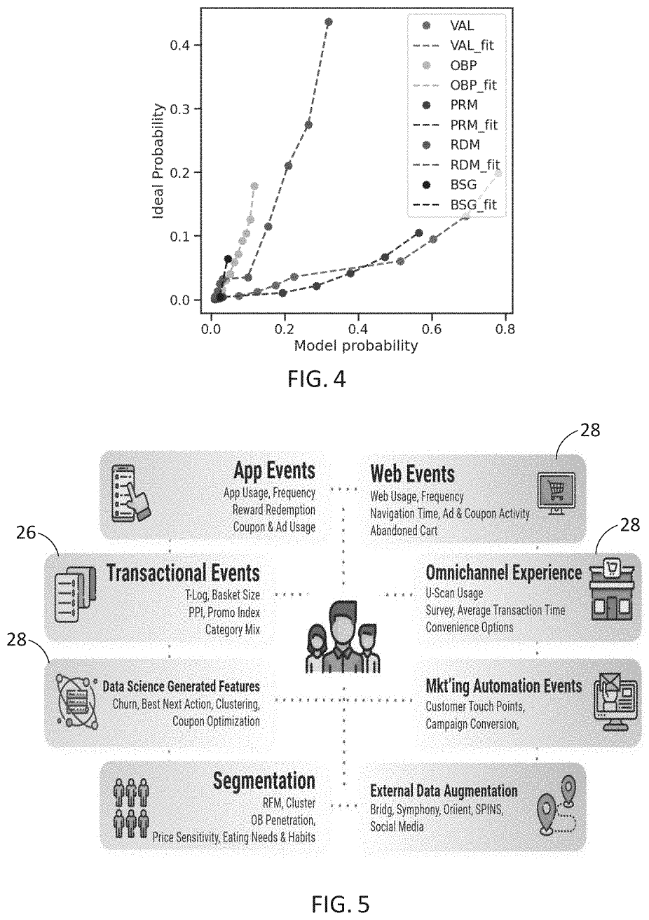

The valuation machine learning model 20 receives the campaign consumer activation profiles to provide assignment of each consumer communication campaigns for communication with particular consumers, such that each consumer is a recipient of an assigned consumer campaign profile. The valuation machine learning model 20 generates assembled consumer activation profiles 22 from each campaign consumer activation profile of the consumer communication campaigns. The assembled consumer activation profiles are generated by alignment between the campaign consumer activation profiles. Referring briefly to FIG. 4, in the illustrative embodiment, the campaign consumer activation profiles are aligned to generate the assembled consumer activation profiles by rescaling each campaign consumer activation profile for equality between false positive ratios across different campaign consumer activation profiles (e.g., normalizing). In the illustrative embodiment, alignment is conducted integrally by the valuation machine learning model 20, but in some embodiments, alignment may be conducted as preparatory for input of the information to the valuation machine learning model 20.

Returning to FIG. 3, the valuation machine learning model 20 valuates 24 each consumer based on the assembled consumer activation profiles. The valuation machine learning model 20 valuates the assembled consumer activation profiles to determine a consumer interval value attributed for each consumer communication campaign. In the illustrative embodiment, the consumer interval value can include the consumer spending per unit time attributable to assignment of the consumer to a particular campaign consumer communication profile. For example, the consumer interval value can be embodied as the consumer's weekly spending attributable to the particular campaign consumer communication profile.

The valuation machine learning model 20 generates a best-next consumer campaign allocation for each consumer based on the valuation 24. The consumer allocation system 12 assigns each consumer to a consumer communication campaign based on the best-next consumer campaign allocation. In the illustrative embodiment, the best-next consumer campaign allocation is determined to be the greatest valuation as the greatest consumer spending per unit time attributable to a particular campaign consumer communication profile. In some embodiments, the valuations for individual assembled consumer activation profiles may be presented to a user for selection of the best-next consumer campaign allocation, for example, by a display of a user interface. In such embodiments, the user may consider the valuations, and can select the greatest or less than the greatest valuation as desired, for example, the second greatest valuation may be selected based on additional information.

Referring to FIG. 5, consumer activity data 16 can include consumer level data and/or program level data. Consumer level data may include consumer specific data, for example, individual consumer transaction events 26 such as transaction frequency, quantity, time of day/month/year; while program level data may include collective data 28 such as coupon data such as coupon activity, survey data, and/or other statistically-derived grouping data. Based on the consumer activity data 16, the consumer allocation system 12 can designate relevant consumer communication campaigns.

Returning briefly to FIG. 3, the assignment of each individual consumer communication campaigns for communication with particular consumers can be returned as feedback information to one or more features of the consumer allocation system 12. Additional feedback information can include consumer responsiveness to the assignment of the particular consumer communication campaign. For example, in the context of a coupon, consumer activation to use the coupon for purchase, save the coupon (electronically), open an electronic mail message, register for additional communications or offers concerning a certain product, brand, or other product aspect, can be applied as feedback information to inform the consumer allocation system 12.

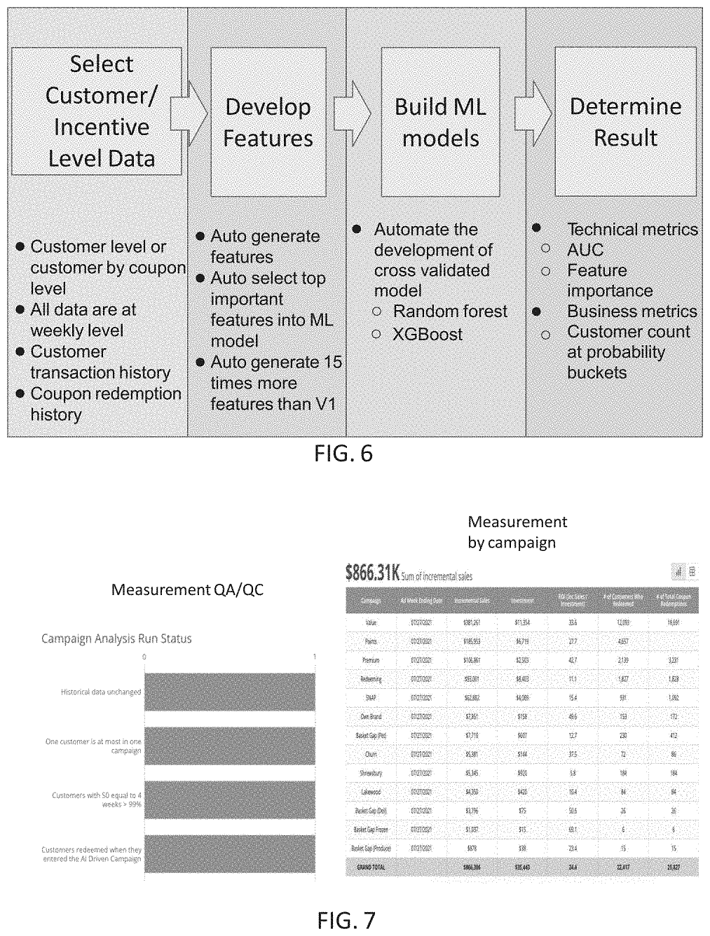

Referring to FIG. 6, the consumer allocation system 12 can establish the consumer communication campaigns. As discussed in additional detail herein, the consumer allocation system 12 can obtain consumer activity data, develop the features for consideration, establish the machine learning model 18, and apply/validate the machine learning model 18 by its campaign consumer activation profile.

In the illustrative embodiment, the consumer allocation system 12 obtains the activity data at the consumer level and program level, which can include combination data. The consumer level activity data illustratively includes duration (time) of the consumer as a consumer member, duration (time) of patronage, lifetime consumer expenditure, sectionalized expenditure history, and pre-campaign consumer history. Sectionalized expenditure can include the average, minimum, and/or maximum by patronage according to UPCs (universal product codes), product family, product section, and/or product department within one week, four weeks, eight weeks, six months, and/or lifetime before the presently assigned (or no assigned) campaign. Pre-campaign consumer history can include the consumer behavior (before designation into a campaign) within one week, four weeks, eight weeks, six months, and/or lifetime before the presently assigned (or no assigned) campaign.

The program level activity data can include coupon data. In the illustrative embodiment, the coupon data includes consumer behavior with respect to UPCs in the campaign communications across all customers. For example, such coupon data can include average spending amount per day, total spending, total tonnage of patronage, number of consumer trips to the store, number of weeks having shopped, and/or number of unique customers shopped with specific-coupon. Such coupon data can include coupon-related characteristics such as average coupon-savings, maximum coupon-savings, clip start date (electronic clip), clip end date (electronic unclip).

Combination data can include consumer behavior for a particular coupon within one week, four weeks, eight weeks, six months, and/or lifetime before the presently assigned (or no assigned) campaign, with respect to UPC, product family, product section, and/or product department in which the consumer communication campaign included coupons according to average spending per day, total spending, total tonnage of patronage, number of consumer trips to the store, number of weeks having shopped, last activity of consumer (concerning specific coupon), PPI (price per item), average basket size (when coupon redeemed), average basket value (when coupon redeemed), average, minimum, and/or maximum number of UPC, product family, product section, and/or product department shopped-within. Exemplary outcomes for generating features for the machine learning models 18 may include Redeem (1—redeem coupon, 0—not redeem), Clip (1—clip coupon, 0—not clip [electronic clipping]), Email open (1—opened, 0—unopened), Push notification (1—opened, 0—unopened).

In the illustrative embodiment, the consumer allocation system 12 determines the features for the machine learning models 18. The consumer allocation system 12 selects the highest impact features for development into the machine learning models 18, for example, according to their outcomes. Within the present disclosure, any suitable manner of feature selection may be applied, for example, random forest feature importance ranking. Consumer behavior can be determined by any suitable manner, for example, within a consumer loyalty program.

The consumer allocation system 12 can establish the machine learning models 18 based on the determined features. The consumer allocation system 12 illustratively builds and cross-validates the individual machine learning models 18 by one or both of random forest and XGBoost, although in some embodiments, the consumer allocation system 12 may apply any suitable manner of model, for example but without limitation, supervised, quasi-supervised, and/or unsupervised learning models, such as linear regression, logistic regression, decision tree, SVM, Naive Bayes, kNN, k-means, dimensionality reduction algorithms, gradient boosting algorithms (e.g., GBM, LightGBM, CatBoost) style models. Referring to FIG. 7, exemplary validation may include consideration of historical data, singular allocation for each customer, consumers redeemed upon joining program in light of incremental sales.

Returning briefly to FIG. 1, the consumer allocation system 12 can add additional consumer communication campaigns 30. The consumer allocation system 12 can obtain activity data and generate features sufficient to generate a new consumer communication campaign, by comparison to the existing portfolio 14. For example, the consumer allocation system 12 can applies a threshold requirement that all generated features be applied by one of the consumer communication campaigns, although in some embodiments, any suitable manner of determining to add additional consumer communication campaigns may be applied. Responsive to determination that a new consumer communication campaign is desired, the consumer allocation system 12 builds and validates the new corresponding machine learning model 18 for implementation. Accordingly, the consumer allocation system 12 can adapt to expand the portfolio 14 as appropriate to accommodate new characteristic campaign considerations.

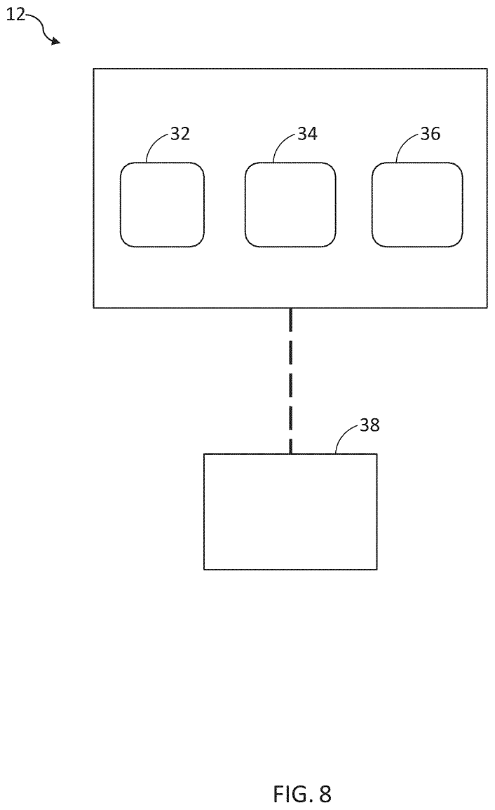

Referring now to FIG. 8, the consumer allocation system 12 illustratively includes processor 32 for executing instructions stored on memory 34, and communication circuitry 36 for communicating signals (to and/or from) based on commands of the processor 32 for conducting consumer allocation system operations. Examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry can include components for facilitating processor operations, for example, suitable components may include transmitters, receivers, modulators, demodulators, filters, modems, analog/digital (AD or DA) converters, diodes, switches, operational amplifiers, and/or integrated circuits.

The consumer allocation system 12 can communicate with external systems and/or devices 38. For example, other servers or resources (e.g., physical, virtual, cloud, internet, intranet, etc.) may provide consumer activity data for use by the consumer allocation system 12. The machine learning models 18, 20 are illustratively implemented on processor 32, which may include one or more processors, but in some embodiments, may be implemented apart from the processor 32 as a semi-integrated or distinct system of execution in communication with the consumer allocation system 12.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure a rising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

We claim:

1. A method of allocating communications for consumers, the method comprising:
obtaining consumer activity data at the consumer level and program level,
designating a number of consumer communication campaigns concerning consumer features based on the consumer activity data at the consumer and program levels,
entering consumer activity data at the consumer and program levels as inputs to one machine learning model for each determined consumer communication campaign, each machine learning model configured to determine a campaign consumer activation profile based on the entered consumer activity data,
assigning consumer communication campaigns for communication based on the determined campaign consumer activation profiles, and
communicating designated consumer communications with each consumer according to the assigned consumer communication campaign.

2. The method of claim 1, wherein assigning consumer communication campaigns for communication includes aligning each campaign consumer activation profile across the consumer communication campaigns.

3. The method of claim 2, wherein aligning includes entering the campaign consumer activation profiles as inputs to a valuation machine learning model to generate assembled consumer activation profiles.

4. The method of claim 3, wherein the assembled consumer activation profiles include rescaling of each campaign consumer activation profile for equality between false positive ratios of each campaign consumer activation profile.

5. The method of claim 4, further comprising valuating each consumer according to each assembled consumer campaign profile to determine a best-next consumer campaign allocation for each consumer.

6. The method of claim 5, wherein valuating each consumer is conducted by the valuation machine learning model to generate the best-next consumer campaign allocation for each consumer based on a determination of the consumer interval value attributed for each consumer communication campaign, and assigning the consumer communication campaigns for communication includes assigning based on the best-next consumer campaign allocation for each consumer.

7. The method of claim 6, wherein assigning based on the best-next consumer campaign allocation includes assigning the consumer communication campaign identified as the best-next consumer campaign allocation for each consumer.

8. The method of claim 1, wherein each designated consumer communication for the consumer communication campaigns is distinct.

9. The method of claim 1, wherein each designated consumer communication of the consumer communication campaigns includes different consumer product information.

10. The method of claim 1, further comprising repeating at least the assigning, and the communicating.

11. The method of claim 10, further comprising repeating obtaining consumer activity data at at least one of the consumer and program levels.

12. The method of claim 10, further comprising repeating the designating.

13. The method of claim 12, wherein repeating the designating includes adding at least one new consumer communication campaign.

14. The method of claim 13, wherein adding at least one new consumer communication campaign includes establishing a machine learning model for the at least one new consumer communication campaign.

15. The method of claim 1, wherein determining a campaign consumer activation profile includes determining a likelihood of consumer activation for a given consumer communication campaign.

16. The method of claim 15, wherein the likelihood of consumer activation for a given consumer communication campaign includes a likelihood of consumer acceptance of a given communication according to the given consumer communication campaign.

17. The method of claim 15, wherein assigning includes determining the likelihood of consumer activation for a given consumer communication campaign by the machine learning model for the given consumer communication campaign.

18. A system for allocating communications for consumers, the system
at least one processor for executing instructions stored on memory for conducting operations including:
obtaining consumer activity data at the consumer level and the program level,
designating a number of consumer communication campaigns concerning consumer features based on the consumer activity data at the consumer and program levels,
entering consumer activity data at the consumer and program levels as inputs to one machine learning model for each determined consumer communication campaign, each machine learning model configured to determine a campaign consumer activation profile based on the entered consumer activity data, and
assigning the number of consumer communication campaigns for communication based on the determined campaign consumer activation profiles; and
communications circuitry for communicating designated consumer communications with each consumer according to the assigned consumer communication campaign from the at least one processor.

19. The system of claim 18, wherein the assigning operations include aligning each campaign consumer activation profile across the consumer communication campaigns.

20. The system of claim 19, wherein the at least one processor includes a valuation machine learning model and aligning includes entering the campaign consumer activation profiles as inputs to the valuation machine learning model to generate assembled consumer activation profiles.

21. The system of claim 20, wherein the assembled consumer activation profiles include rescaling of each campaign consumer activation profile for equality between false positive ratios of each campaign consumer activation profile.

22. The method of claim 21, further comprising valuating each consumer according to each valuation consumer campaign profile to determine a best-next consumer campaign allocation for each consumer.

23. The method of claim 22, wherein valuating each consumer is conducted by the valuation machine learning model to generate the best-next consumer campaign allocation for each consumer based on a determination of the consumer interval value attributed for each consumer communication campaign, and assigning the consumer communication campaigns includes assigning based on the best-next consumer campaign allocation for each consumer.

24. The method of claim 23, wherein assigning based on the best-next consumer campaign allocation includes assigning the consumer communication campaign identified as the best-next consumer campaign allocation for each customer.

25. The system of claim 18, further comprising repeating the designating.

26. The method of claim 25, wherein repeating the designating includes adding at least one new consumer communication campaign.

27. The method of claim 26, wherein adding at least one new consumer communication campaign includes establishing a machine learning model for the at least one new consumer communication campaign.
